(19) United States
(12) Patent Application Publication
(10) Pub. No.: US 2019/0185134 A1
(43) Pub. Date: Jun. 20, 2019

(54) Adjustable Fuselage Location Joint Method

(71) Applicant: Thomas Hsueh, Anacortes, WA (US)

(72) Inventor: Thomas Hsueh, Anacortes, WA (US)

(21) Appl. No.: 15/846,612

(22) Filed: Dec. 19, 2017

(51) Int. Cl. B64C 1/26; B64C 3/38

(52) U.S. Cl. CPC B64C 1/26; B64C 1/064; B64C 3/38

(57) ABSTRACT

The adjustable fuselage location method is based on the combined use of slots under fuselage longerons, saddles between fuselage and wing, straps, brackets, thread poles and nuts. Saddles installed under the fuselage provide an interface between the fuselage and wing. Straps wrap around the brackets inside fuselage longerons, saddles and wing box for fastening the wing to the fuselage. Thread poles are affixed on the brackets for guiding the traveling of fuselage in longitudinal direction. By turning the nuts on the poles, fuselage can be relocated on the wing. These adjusting mechanisms can be hided inside the longerons of fuselage and manipulated from inside of the fuselage.

### BACKGROUND

The traditional method of joining an aircraft wing and fuselage is by bolting the two structures together. In the case, fuselage is fixed to the wing at the designed location permanently after the aircraft is manufactured. Thus, a new design of fastening fuselage and wing should be introduced to achieve for changing the location of fuselage on wing. By changing the location of fuselage, it allows to adjust the center of gravity of the aircraft either on the ground or during flight.

Accordingly, it is a general aim of the present an invention to provide a new method to joint aircraft fuselage and wing which allows the fuselage to move on the wing. This method avoids the use of through-structural fasteners and the need to drill holes through the fuselage and the wing.

### BRIEF DESCRIPTION

A joint method includes the assembly of brackets inside fuselage longerons, two saddles between fuselage and the wing, strap pillows located atop of the base blocks of saddles. Straps tie the strap pillows, brackets, saddles and wing box together. The two saddles are placed on the top of both front and rear spars of the wing box. Each saddle has a curvature on the top to fit the fuselage bottom curvature and a curvature at the bottom to fit the wing top curvature. Eight slots are presented at the bottom of fuselage longerons providing the access for the base block of saddles and straps. The strap pillows are located on the top of the base blocks of saddles, and each saddle has four base blocks the top providing sittings for the strap pillows. The strap pillows provide the sitting for straps placement and the connection to brackets inside the fuselage longerons. The straps wrap around strap pillows, brackets, saddles and wing together and joint at the bottom of wing by turnbuckles.

This joint method includes the mechanism which allows change the fuselage location after installed on the wing. The mechanism parts include strap pillows, thread poles, thread pole brackets, two nuts on each thread pole. The nuts and thread poles constrain the location of the fuselage on the wing in longitude direction, and brackets provide the guide to the travel of fuselage. By turning the nuts, we are able to position and adjust the location of the fuselage on the saddles.

The features and functions can be achieved independently in various embodiments of the present disclosure or may be combined in yet other embodiments in which further details can be seen with reference to the following description and drawings.

### DESCRIPTION OF DRAWINGS

FIG. 1 is the trimetric view of the combination of fuselage and the center wing box.

FIG. 2 is the front view of the combination of fuselage and the center wing box.

FIG. 3 is the front view of the combination of center wing box, saddle, straps and moving mechanism.

FIG. 4 is the detail view of the moving mechanism.

FIG. 5 is the side view of the combination of center wing box, saddles, straps and moving mechanism.

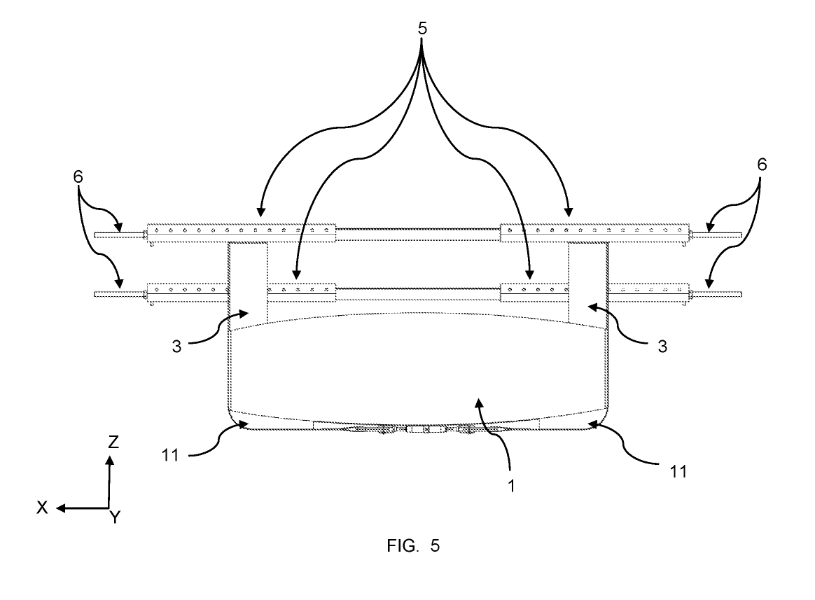

FIG. 6 is the trimetric view of the saddle.

FIG. 7 is the top view of the combination of the moving mechanism and the strap.

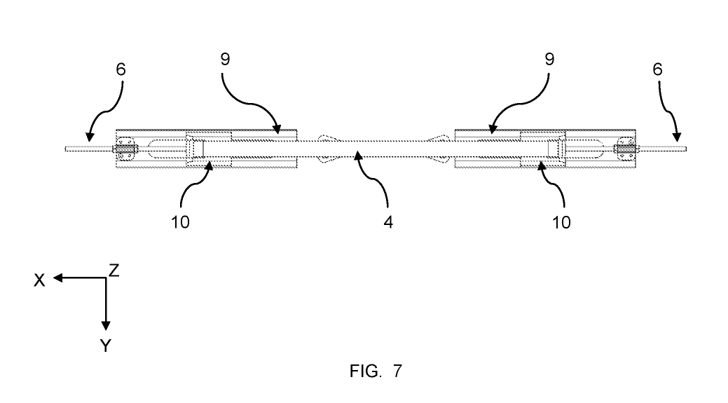

FIG. 8 is the bottom view of the combination of the mechanism and the strap.

### DETAILED DESCRIPTION

This method presents a fuselage and wing joint method which provides a moving mechanism to change the fuselage location on wing in longitudinal axis. Instead bolting the wing direct to the fuselage, the wing is fastened to the fuselage by straps, and two modified saddle blocks in between for matching.

Reference system determined by a longitudinal X axis oriented positively toward front of the aircraft, a vertical Z axis perpendicular to the X axis and oriented positively toward a top of the aircraft and a lateral Y axis perpendicular to the plane defined by the X and Z axes and oriented positively toward a left side of the aircraft.

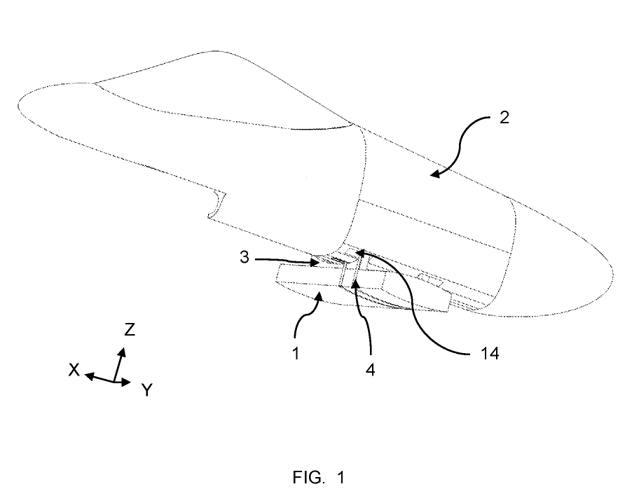

Wing box 1 is located under the bottom of fuselage 2, shown in FIG. 1. Two saddles 3 are placed between wing box 1 and fuselage 2 as interfaces. Eight slots present under the bottom of fuselage 2. These slots provide the through holes for saddles 3 and straps 4, the length of the slots is the traveling range of fuselage 2 on wing box 1. Front saddle 3 is located above the front spar of wing box 1 and up through the front four slots of fuselage 2, and rear saddle 3 is located above the rear spar of wing box 1 and up through the rear slots of fuselage 2. Straps 4 wrap around the saddles 3, brackets inside the fuselage, and wing box 1 to fasten them together.

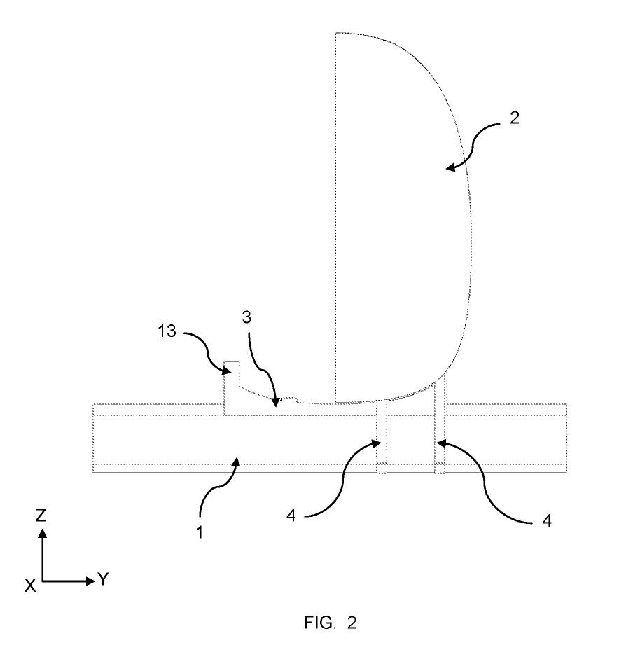

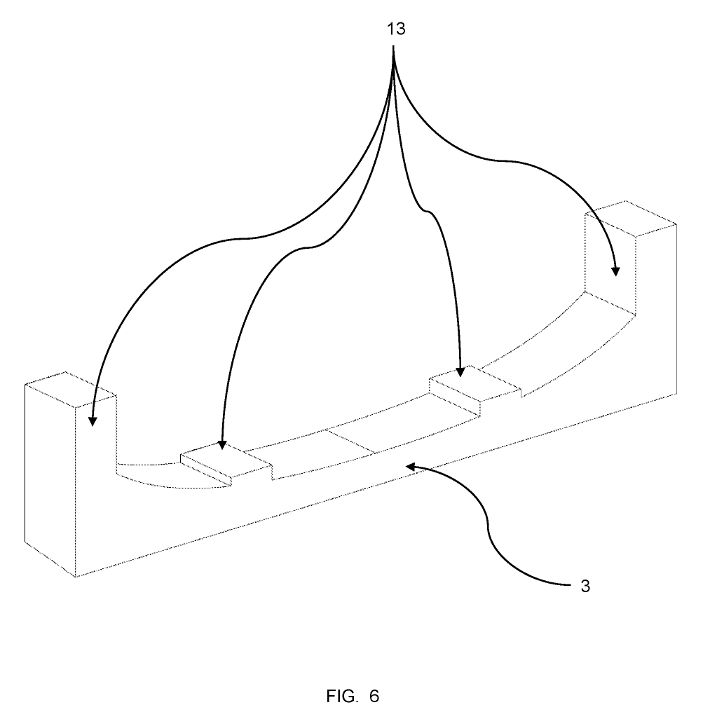

FIG. 2 shows the front view of the combination of fuselage 2, saddle 3 and wing box 1. Each saddle, shown in FIG. 6, featured four small base blocks 13 on top serve as the sitting bases for the moving mechanism assemblies.

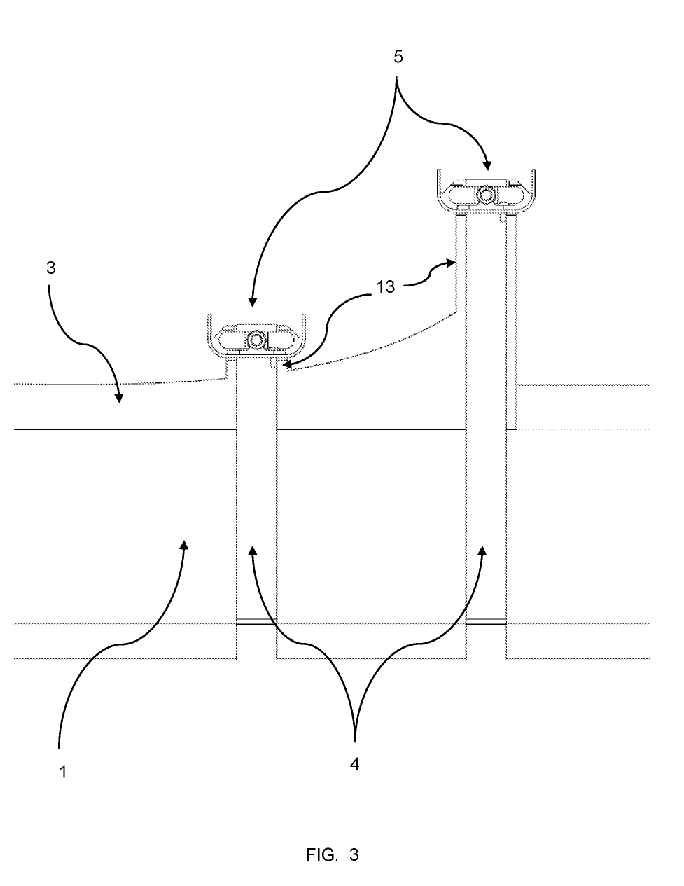

FIG. 3 shows the detail combination front view of wing box 1, saddle 3 and moving mechanism assemblies 5. Moving mechanism assemblies 5 are sitting on the base blocks 13 of saddle 3. Straps 4 wrap around moving mechanism assemblies 5, saddle 3 and wing box 1.

Saddle 3, shown in FIG. 6, is shaped to fit the curvature of fuselage 2 and wing box 1. The top surface is shaped to fit the bottom curvature of fuselage 2, and bottom surface is shaped to fit the top curvature of wing box 1. By this configuration, bracket 9 is able to seat atop of base block 13. Than straps 4 fasten them together to complete the joint of fuselage 2 and wing box 1.

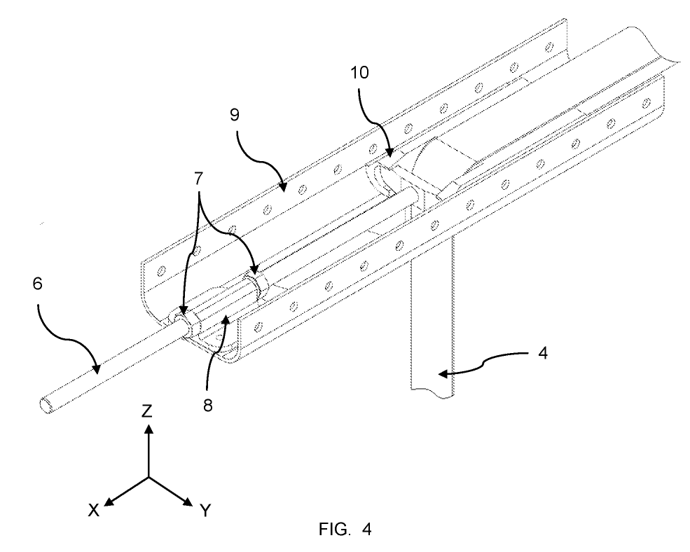

FIG. 4 shows the detail view of moving mechanism assembly 5. Bracket 9 is bolted to the inside of fuselage bottom longeron and provide as the track allowed strap pillow 10 sitting and sliding on it. A long slot appears at the bottom of bracket 9 allows strap 4 go through to saddle 3 and wing box 1. One side of Thread pole 6 is affixed to strap pillow 10. The four thread poles 6 at front are pointing to the nose of fuselage 2, the other four thread poles 6 at the rear pointing to the tail of fuselage 2. A pole bracket 8 is mounted on bracket 9, located at the end without covered by strap 4. Two nuts 7 are fastened to the sides of pole bracket 8 provide the constraint on thread pole 6. By turning the nuts 7, the constrained location of pole bracket 8 on thread pole 6 is changed. Simultaneously, bracket 9 and fuselage 2 can be moved on the wing in longitude direction.

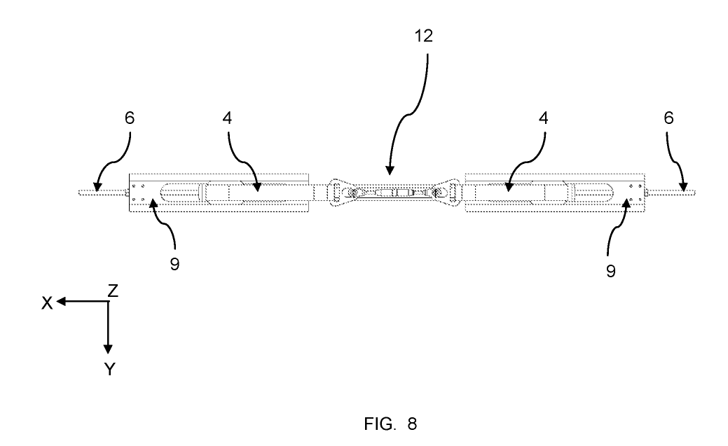

To join two ends of strap 4, a turnbuckle and two buckles can be applied, shown in FIG. 8. One end of buckle is fastened to the end of strap 4, the other end connects with the fork of turnbuckle. By turning the turnbuckle, the strap 4 is tightened and so immobilized the assembly.

What is claimed is:

1. An adjustable fuselage and wing joint mechanism comprising:
a fuselage with pairs of slots under the bottom longerons, wherein said slots are the access holes for base blocks of saddles and straps, the length of the slots is the traveling distance for fuselage on the wing;
a pair of shaped saddles between fuselage and wing box, wherein said saddle is configured to top surface curvature matching the bottom curvature of the fuselage, bottom surface curvature matching the top curvature of the wing box;
a wing box;
a set of straps;
a set of bracket tracks, which are installed on the slots of fuselage bottom longerons, wherein said bracket tracks are holding the strap pillows and configured with a slot at the bottom for strap accessibility;
a strap pillow affixed on the base block of saddle, wherein said strap pillow provides sitting for strap and thread pole;
a thread pole installed on the strap pillow and align with longitude axis which provides the guide for the traveling of fuselage;
a pole bracket, which is installed on the end not covered by the strap and provides the constraint to the thread pole;
a pairs of nuts, which are fastened on the thread pole and the sides of the pole bracket, wherein said the nuts constrain the location of the fuselage;
a turnbuckle and two buckles are used to join the two ends of the strap.
